(19) United States
(12) Patent Application Publication
(10) Pub. No.: US 2012/0141844 A1
(43) Pub. Date: Jun. 7, 2012

(54) Galvanic Cell Having Overpressure Protection

(75) Inventors: Arnold Lamm, Elchingen (DE); Jens Meintschel, Bernsdorf (DE); Dirk Schroeter, Winnenden (DE)

(73) Assignee: Daimler AG, Stuggart (DE)

(21) Appl. No.: 13/387,856

(22) PCT Filed: Jul. 3, 2010
(86) PCT No.: PCT/EP2010/004048

§ 371 Date: Feb. 22, 2012

(30) Foreign Application Priority Data
Jul. 31, 2009 (DE) 10 2009 035 457.3

(51) Int. Cl. H01M 2/12; B29C 45/14

(52) U.S. Cl. 429/56; 264/272.14

(57) ABSTRACT

A single cell having a casing formed from a first casing side part, a second casing side part and a casing frame, in which casing an electrolyte and an electrochemically active electrode foil unit are arranged, wherein the casing comprises an overpressure protection. The first casing side part includes a casing side part segment going at least sectionally over a length of the single cell, which casing side part segment is angled down in relation to the first casing side part in the direction of the cell interior and in which the overpressure protection is arranged and a venting opening is incorporated into the casing frame in a region of the overpressure protection.

### BACKGROUND AND SUMMARY OF THE INVENTION

The invention relates to a single cell for a battery and a method for producing a casing frame with a venting opening for use in a single cell.

An explosion-proof arrangement is described in the prior art, as in European Patent Publication EP 0 266 541 A1, for a non-aqueous electrochemical battery and a method for producing it. A plurality of grooves are formed in a non-aqueous electrochemical battery on the bottom of the battery container, in which grooves the material thickness of the bottom of the battery container is reduced. The grooves intersect at least at one point and a bottom region of the grooves is flat so that the explosion-proof arrangement can be triggered with a predefined internal pressure of the battery.

European Patent Publication EP 1 321 993 A2 discloses a battery cell safety valve and a battery equipped with the valve. A battery cell comprises a positive electrode, a negative electrode, an electrolyte solution and an outer casing. The outer casing comprises a valve plate, an annular predefined breaking point on the valve plate and one or more auxiliary breaking points in a region surrounded by the annular predefined breaking point. The auxiliary breaking point is formed in such a way that a remaining thickness of the valve plate in the region of the auxiliary breaking point is greater than in the region of the annular predefined breaking point. At least one end of the auxiliary breaking point is connected to the annular predefined breaking point. If such a valve plate is integrated as a safety valve into a battery cell the safety valve functions smoothly and allows a gas forming in the battery cell to flow out quickly.

U.S. Pat. No. 5,688,615 discloses a bipolar battery and a method for production thereof. The bipolar battery comprises a casing, which comprises filling openings for filling with electrolyte and which are arranged, for example, in a casing frame of the casing. The casing can be completely closed or can be vented.

U.S. Pat. No. 7,122,276 B2 discloses a flat cell with a safety valve. The flat cell comprises a safety valve that prevents, in case of an increasing internal temperature due to overcharging, over-discharging or overheating, an explosion or a fire due to the cell internal pressure being too great by triggering an opening mechanism on the casing of the flat cell. For this purpose at least one opening part is arranged at a closure point of the flat cell, wherein the opening part which is made of epoxy resin has a lower melting point than the closure point of the flat cell.

PCT Patent Publication WO 94/10708 discloses a battery arrangement comprising a valve. A one-way valve is integrated into a protective shell surrounding a stack of foils. After the protective shell has been closed, the battery arrangement is evacuated via the valve. If a pressure within the protective shell is greater than outside of the protective shell gases and liquids flow from the protective shell via the valve to outside.

Exemplary embodiments of the present invention provide an improved single cell for a battery, a battery which is improved having regard to the prior art and a method for producing a casing frame for use in a single cell.

A single cell, in particular a flat cell, comprises a casing formed by a first casing side part, a second casing side part and a casing frame, in which casing an electrolyte and an electrochemically active electrode foil unit are arranged, wherein the casing comprises an overpressure protection.

According to the invention the first casing side part comprises a casing side part segment going at least sectionally over a length of the single cell and which is angled down in relation to the first casing side part in the direction of the cell interior and in which the overpressure protection is arranged and a venting opening is incorporated in the casing frame in a region of the overpressure protection.

In single cells of a battery, in particular a lithium-ion battery, a temperature and a cell internal pressure increase considerably in case of a malfunction of the single cell, for example in case of a short circuit or overcharging, as an electrochemically active mass contained in the single cells, for example nickel oxide, is thermally unstable and breaks down irreversibly in an exothermic reaction above a certain temperature. Through this breaking-down process the single cell heats further and the cell internal pressure increases further. This can lead to such a single cell or a battery equipped with these single cells exploding and/or catching fire.

In order to prevent this, in accordance with exemplary embodiments of the present invention, upon exceeding a maximum admissible cell internal pressure the overpressure protection opens so that gases and/or liquids can escape from the cell interior in a controlled manner. The overpressure protection can be arranged in the region of the casing frame of the single cell. This is highly significant particularly with flat cells designed as single cells, as these are arranged in the battery with their casing side parts pressed against each other so that the overpressure protection cannot be arranged at the side. The overpressure protection cannot, however, be directly integrated into the casing frame if this is produced from thermoplastic material as otherwise the overpressure protection triggers in dependence upon the temperature with different cell internal pressure conditions. This can be prevented with an overpressure protection arranged in the region of the casing frame as the overpressure protection is arranged in the casing side part segment that is not produced from a temperature-sensitive material. Triggering of the overpressure protection in case of a predefined cell internal pressure is thereby ensured irrespectively of the temperature of the single cell. The venting opening in the casing frame ensures that upon triggering of the overpressure protection gases and/or liquids can escape from the cell interior through the casing frame in a controlled manner.

The overpressure protection is usefully formed through a predefined weakening of a material of the casing side part segment, preferably through a predetermined breaking point. In this way it can be ensured in an easy-to-implement and cost-effective way that the casing breaks at a predefined point in the predefined way in case of a maximum admissible cell internal pressure being exceeded so that gases and/or liquids can escape from the cell interior in a controlled manner. It is thereby possible to prevent the single cell exploding and/or catching fire and to prevent dangers resulting therefrom.

The casing side part segment is angled down at a right angle in an advantageous embodiment. In a particularly advantageous embodiment the casing side part segment is repeatedly angled down in the direction of an inner surface side of the first casing side part. Repeated angling down the casing side part segment can also be used to anchor the first casing side part in the casing frame so that the form and stability of the casing are maintained even in case of an increased cell internal pressure. It is further ensured in this way that a position and orientation of the overpressure protection remain constant so that an exact triggering of the overpressure protection and a controlled release of gases and/or liquids from the cell interior are ensured.

The casing side part segment preferably comprises a recess. This is advantageous particularly with the described repeated angling down of the casing side part segment as a controlled release of gases and/or liquids from the cell interior can take place through this recess if the overpressure protection is open. It is thereby ensured that even with a repeatedly angled down casing side part segment a release of gases and/or liquids is not hindered or blocked through the casing side part segment.

In a preferred embodiment the overpressure protection is arranged on a side of the casing frame facing the cell interior so that the venting opening in the casing frame can be used as a venting chamber as gases and/or liquids flow first of all through the overpressure protection and then through the venting opening in the casing frame arranged behind it in the flow direction. This arrangement also ensures that the safety valve is not blocked even after incorporation of the single cell, for example, into a battery casing as a free space is formed through the venting opening in the casing frame so that a controlled break-out of the casing in the region of the overpressure protection is ensured upon exceeding of a maximum admissible cell internal pressure. Furthermore, a flow direction can be predefined through a suitable formation of this venting opening, for example in the direction of a venting chamber in a battery casing. An uncontrolled distribution of these gases and/or liquids can thereby be prevented.

In a further embodiment the overpressure protection is arranged on a cell outer side of the casing frame. This embodiment is easier to produce as no repeated angling down of the casing side part segment is necessary for this purpose. However, with this embodiment after incorporation of the single cell, for example, into a battery casing the overpressure protection should not be blocked.

The casing side part segment is advantageously connected to the casing frame in a shape locking and/or force locking way. In a particularly preferred embodiment the casing side part segment is at least partially surrounded by a material of the casing frame. This ensures that a form and stability of the casing are maintained even with an increased cell internal pressure so that upon an increase in the cell internal pressure a premature and uncontrolled destruction of the casing is prevented. This further ensures that the position and orientation of the overpressure protection remain constant so that an exact triggering of the overpressure protection and a controlled release of gases and/or liquids from the cell interior are ensured.

In order to ensure stability and compressive strength of the casing the casing side parts are preferably riveted to the casing frame. In a further advantageous embodiment edge regions of the casing side parts are angled down so that they at least partially surround the casing frame. Through such production variants a solid and pressure-resistant closure of the casing is guaranteed.

A battery comprises a plurality of single cells electrically connected to each other in series and/or in parallel, wherein the single cells, in particular flat cells, are preferably arranged closely one behind the other and orientated parallel to each other. This achieves an arrangement of the single cells optimally saving construction space. As cell poles of the single cells lie on the casing side parts of the casing the single cells are preferably arranged with their casing side parts pressing against each other, whereby two casing side parts respectively in contact with each other have a different polarity and can be connected to each other electrically in series. In this way optimum contacting of the single cells can be achieved and production of the battery considerably facilitated.

In an inventive method for producing a casing frame with a venting opening for use in a single cell a first casing side part is arranged in an injection mould which is subsequently closed and filled with plastic, whereby a movable mould part of the injection mould is arranged on an angled down casing side part segment in a region of an overpressure protection. In this way a casing frame for the single cells can be produced in a simple and cost-effective way in mass production and fixed to the first casing side part. Through an at least partial casting of the first casing side part, in particular the casing side part segment, in the casing frame a very solid shape-locking connection is produced whereby the casing can be connected in a pressure-resistant way and an exact positioning of the overpressure protection is also ensured in case of an increased cell internal pressure. By means of the movable mould part, a venting opening is produced in the casing frame that is positioned exactly in the region of the overpressure protection. Because this mould part is movable it can be removed after hardening of the casing frame and the first casing side part with injected casing frame can be removed without problems from the injection mould.

The mould part is preferably pressed spring loaded against the angled down casing side part segment. Through this spring loaded contact manufacturing tolerances of the first casing side part and the casing side part segment can be balanced. This ensures that the mould part is always optimally pressed against the casing side part segment so that an exact positioning of the venting opening is ensured in the casing frame. It is thereby ensured that no material of the casing frame covers and blocks the overpressure protection.

### BRIEF DESCRIPTION OF THE DRAWING FIGURES

Embodiments of the invention are explained by reference to drawings, in which:

FIG. 1 shows a first perspective view of a first casing side part,

FIG. 2 a second perspective view of a first casing side part,

FIG. 3 a schematic representation of a first casing side part with casing frame in a mould,

FIG. 4 a first perspective view of a first casing side part with casing frame,

FIG. 5 a second perspective view of a first casing side part with casing frame,

FIG. 6 an exploded view of a single cell,

FIG. 7 a vertical section through a single cell in the region of the overpressure protection and

FIG. 8 a perspective view of a battery.

Parts corresponding to each other are provided with the same reference numerals in all the drawings.

### DETAILED DESCRIPTION

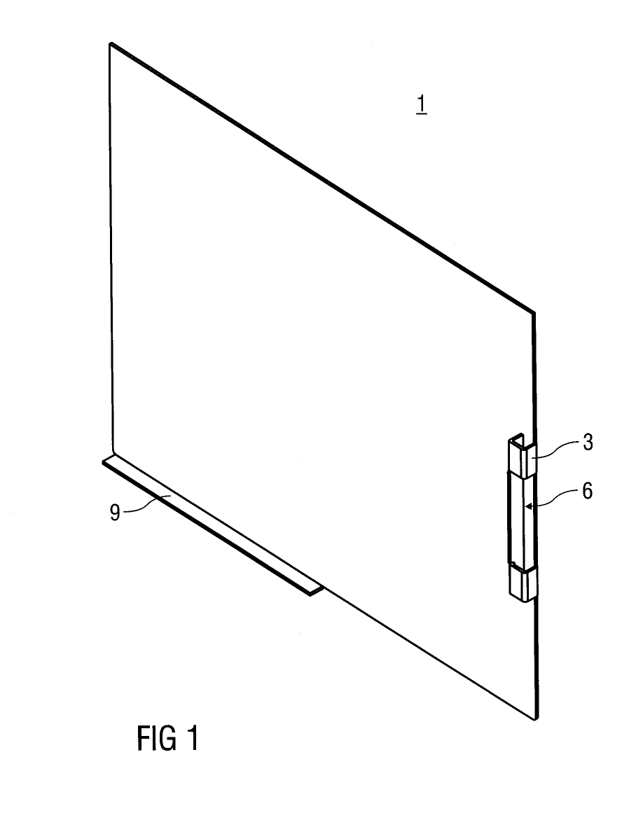

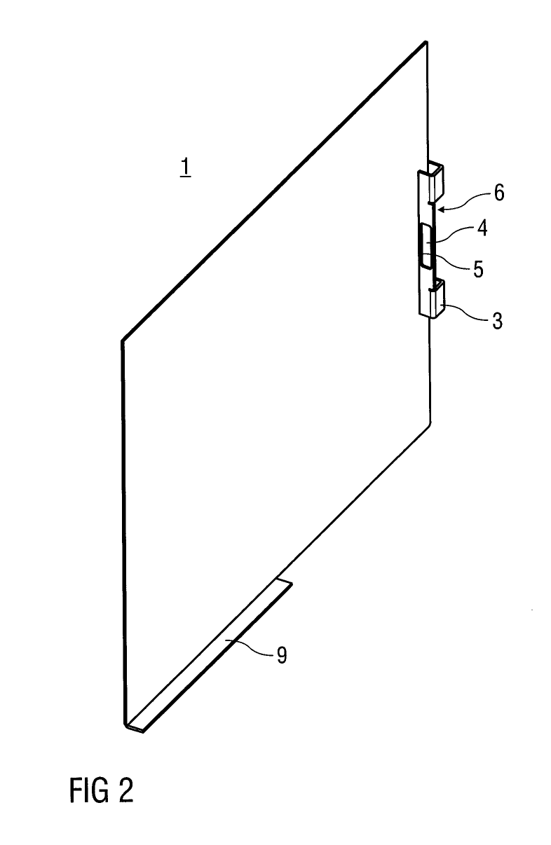

FIGS. 1 and 2 show perspective views of a first casing side part 1 of a single cell 2. The first casing side part 1 comprises a casing side part segment 3 going sectionally over a length of the single cell 2. The casing side part segment 3 is angled down three times in the direction of an inner surface side of the first casing side part 1 in the embodiment shown here. The casing side part segment 3 comprises, on a surface orientated to a cell interior, an overpressure protection 4 through a predefined weakening of a material of the casing side part segment 3. In the embodiment shown here the material of the casing side part segment 3 is weakened by an annular predefined breaking point 5. The casing side part segment 3 further comprises a recess 6 so that the overpressure protection 4 is not covered by the casing side part segment 3. After triggering the overpressure protection 4, gases and/or liquids can thus escape from the cell interior through the overpressure protection 4 and through the recess 6 in the casing side part segment 3.

The first casing side part 1 and also a second casing side part 7 of the single cell 2 further comprise, on a side facing a cooling plate 8, a casing side part element 9 going at least sectionally over a length of the single cell 2. The casing side part element 9 is angled down in relation to the respective casing side part 1, 7 in the direction of the cell interior. In this way the single cell 2 can be optimally thermally coupled to the cooling plate 8 as a heat loss of the single cell 2 can be transferred from the casing side parts 1, 7 via the angled down casing side part elements 9 to the cooling plate 8.

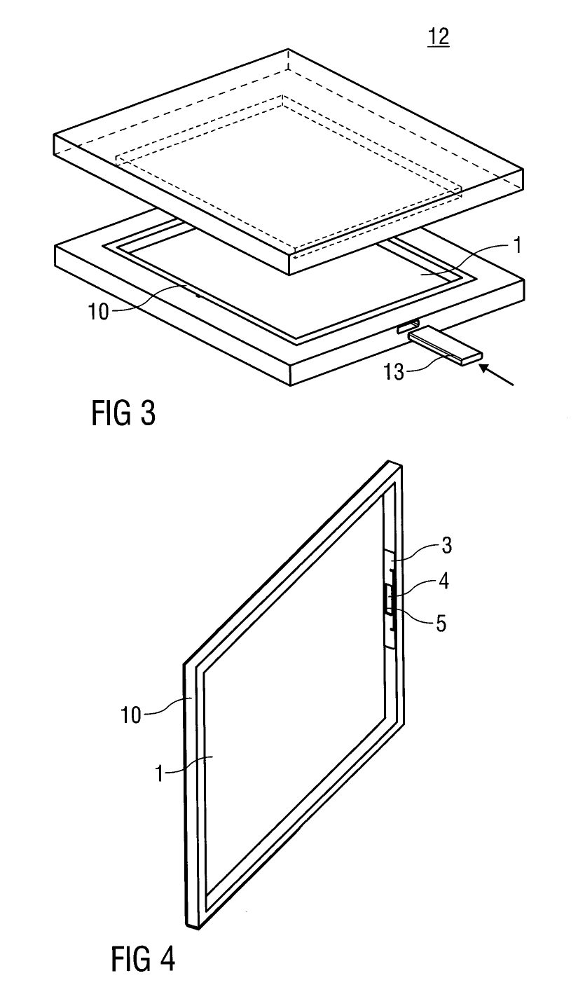

In a method for producing a casing frame 10 with a venting opening 11 for use in a single cell 2, as shown in FIG. 3, the first casing side part 1 is placed in an injection mould 12 in order to produce the casing frame 10 from a plastic, preferably a thermoplastic material, and to connect it in a shape-locking way to the first casing side part 1, in particular to the casing side part segment 3. In order to avoid closing the overpressure protection 4 with the casing frame 10, a movable mould part 13 of the injection mould 12 is pressed against the angled down casing side part segment 3 in a region of the overpressure protection 4, preferably with spring loading before the plastic is injected into the injection mould 12. The spring loaded contact ensures that, for example also in case of manufacturing tolerances of the first casing side part 1 or the casing side part segment 3, the mould part 13 lies against the casing side part segment 3 in the region of the overpressure protection 4.

This mould part 13 prevents the overpressure protection 4 from being covered with plastic or covered by the casing frame 10 and thereby becoming unfit for its function. The casing frame 10 is formed by closing the injection mould 12 and injecting the plastic into the injection mould 12, whereby in the embodiment shown here the casing side part segment 3 is at least partially cast into the casing frame 10 and thus anchored in a shape-locking way in the casing frame 10. The injection mould 12 is then opened, the mould part 13 removed and the first casing side part 1 is removed with the injected casing frame 10 from the injection mould 12.

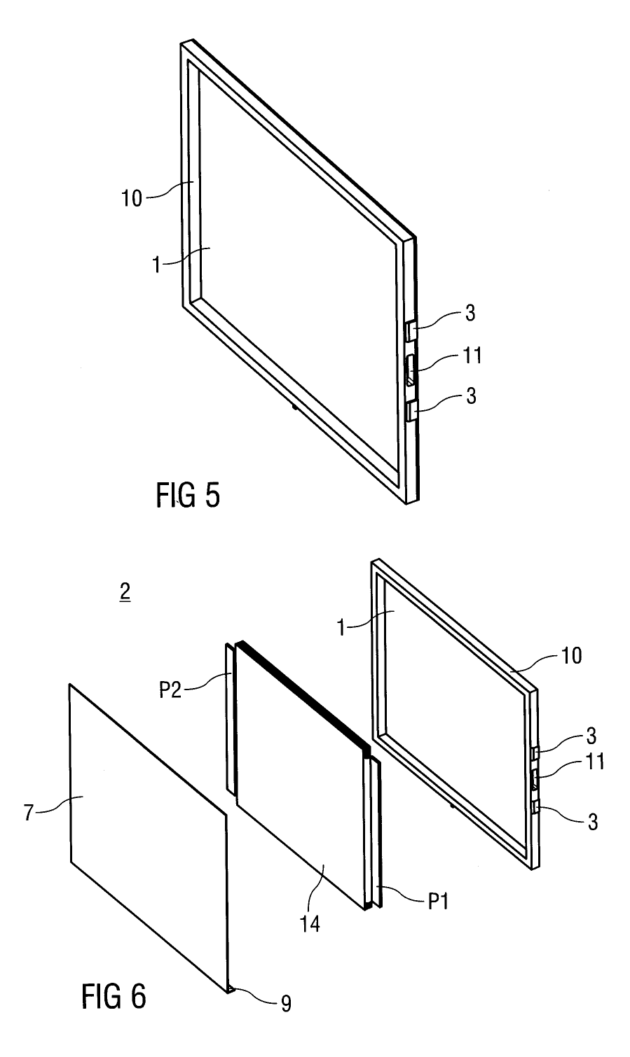

Such a first casing side part 1 with injected casing frame 10 made of plastic is shown in FIGS. 4 and 5 from a first and a second perspective view. Through the mould part 13 pressed against the casing side part segment 3 in the region of the overpressure protection 4 the venting opening 11 is formed in the casing frame 10 in the region of the overpressure protection 4, through which venting opening 11 a controlled release of gases and/or liquids from the cell interior is ensured after triggering of the overpressure protection 4.

FIG. 6 shows an exploded view of the single cell 2. The single cell 2 comprises an electrochemically active electrode foil unit 14, an electrolyte (not shown) and a casing, formed from the first casing side part 1 with injected casing frame 10 and the second casing side part 7. Cell poles P1, P2 of the electrode foil unit 14 are contacted, after putting together the single cell 2 with a respective casing side part 1, 7, whereby these form pole contacts of the single cell 2. As a plurality of these single cells 2 are preferably arranged in a battery 15 closely one behind the other and orientated parallel to each other for the purpose of optimum use of construction space, the single cells 2 can be electrically connected in series with each other by pressing their casing side parts 1, 7 against each other, wherein two respective casing side parts 1, 7 in contact with each other have a different polarity. In this way optimum contacting of the single cells 2 can be achieved and a production of the battery 15 is considerably facilitated.

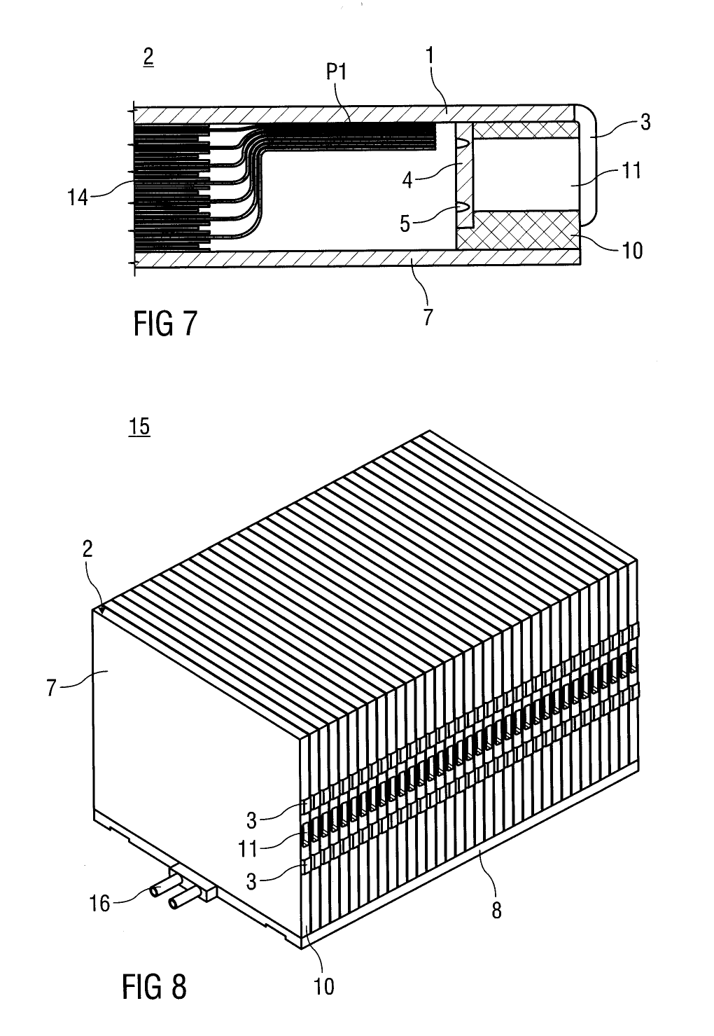

FIG. 7 shows a vertical section through the single cell 2 in the region of the overpressure protection 4. The casing of the single cell 2 is closed by putting together the two casing side parts 1, 7 and the casing frame 10, for example, by means of a hot pressing method. In order to increase a compressive strength of the casing the casing side parts 1, 7 can also be riveted to the casing frame 10 for example alternatively or additionally, for example through plastic rivets formed from casing frame material. In a further embodiment not shown here, edge regions of the casing side parts 1, 7 are angled down in such a way that they at least partially surround the casing frame 10, whereby the compressive strength of the casing can also be increased. A first cell pole P1 of the electrode foil unit 14 is electrically contacted with the first casing side part 1. A further cell pole P2 (not shown here) of the electrode foil unit 14 is electrically contacted with the second casing side part 7.

Through the casing side part segment 3 angled down three times in the direction of the inner surface side of the first casing side part 1 the overpressure protection 4, which is formed by the predefined weakening of the material of the casing side part segment 3 through the annular predefined breaking point 5, is arranged in the region of a side of the casing frame 10 orientated to the cell interior. The casing side part segment 3 is partially cast into the material of the casing frame 10 and thereby connected to it in a shape-locking way. The venting opening 11 in the casing frame 10 is positioned in the region of the overpressure protection 4. If a cell internal pressure of the single cell 2 greatly increases in case of a malfunction, for example a short circuit or overcharging, and exceeds a maximum admissible cell internal pressure the casing breaks along the predefined breaking point 5, whereby gases and/or liquids can escape from the cell interior in a controlled way.

These gases and/or liquids can flow out of the single cell 2 unhindered through the venting opening 11 in the casing frame 10 and the recess 6 in the casing side part segment 3, whereby the single cell 2 can be prevented from exploding and/or catching fire. The shape-locking connection of the casing frame 10 to the casing side part segment 3 ensures that the single cell 2 does not deform even in case of increased cell internal pressure so that a position and orientation of the overpressure protection 4 remain constant having regard to the venting opening 11 in the casing frame 10. This means that upon triggering of the overpressure protection 4 the gases and/or liquids can flow to the outside through the casing frame 10 via the valve opening 11 without hindrance. Through a suitable formation of this venting opening 11 a flow direction can be predefined for example in the direction of a venting chamber in a battery casing. Uncontrolled distribution of the gases and/or liquids can hereby be avoided.

FIG. 8 shows a perspective view of the battery 15. A plurality of single cells 2 are arranged closely one behind the other and orientated parallel to each other in the battery 15 in order to ensure optimum use of construction space. By pressing their casing side parts 1, 7 against each other the single cells 2 can be electrically connected to each other in series, as two respective casing side parts 1, 7 in contact with each other have a different polarity. In this way optimum contacting of the single cells 2 can be achieved and production of the battery 5 considerably facilitated.

The single cells 2 are arranged on a cooling plate 8, through which a coolant flows and which is connected via a coolant connection 16, for example, to a cooling circuit of a vehicle. For electrical insulation and improved heat transfer a heat conducting foil (not shown here) is arranged between the single cells 2 and the cooling plate 8. In this way a heat loss of the single cells 2 can be transferred to the cooling plate 8 and be transported away from the battery 15 through the coolant.

Through the overpressure protection 4 and the venting opening 11 arranged in the casing frame 10 of each single cell 2 in the region of the overpressure protection 4 gases and/or liquids can escape from the cell interior of the defective single cell 2 in a controlled manner, for example into the battery casing (not shown here), in case of an overpressure caused for example by a malfunction. In this way it is possible to avoid the single cell 2 exploding and/or catching fire and to avoid risks resulting therefrom.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 First side part

2 Single cell

3 Side part segment

4 Overpressure protection

5 Predefined breaking point

6 Recess

7 Second side part

8 Cooling plate

9 Side part element

10 Frame

11 Venting opening

12 Injection mould

13 Mould part

14 Electrode foil unit

15 Battery

16 Coolant connection

P1, P2 Cell poles

1-15. (canceled)

16. A single cell casing, comprising:
a first casing side part;
a second casing side part;
a casing frame;
an electrolyte and an electrochemically active electrode foil unit; and
an overpressure protection,
wherein the first casing side part comprises a casing side part segment at least sectionally along a length of the single cell, the casing side part segment is angled down in relation to the first casing side part in a direction of an interior of the cell, and an overpressure protection is arranged the side casing part segment, and a venting opening is incorporated in the casing frame in a region of the overpressure protection.

17. The single cell according to claim 16, wherein the overpressure protection is formed by a predefined weakening of a material of the casing side part segment.

18. The single cell according to claim 16, wherein the overpressure protection is formed by a predefined breaking point.

19. The single cell according to claim 16, wherein the casing side part segment is angled down at a right angle.

20. The single cell according to claim 16, wherein the casing side part segment is angled down repeatedly in the direction of an inner surface side of the first casing side part.

21. The single cell according to claim 16, wherein the casing side part segment comprises a recess.

22. The single cell according to claim 16, wherein the overpressure protection is arranged on a side of the casing frame facing the interior of the cell.

23. The single cell according to claim 16, wherein the overpressure protection is arranged on a cell outer side of the casing frame.

24. The single cell according to claim 16, wherein the casing side part segment is connected to the casing frame in a shape-locking, material-locking or force-locking way.

25. The single cell according to claim 16, wherein the casing side part segment is at least partially surrounded by a material of the casing frame.

25. The single cell according to claim 16, wherein the casing side parts are connected by rivets to the casing frame.

27. The single cell according to claim 16, wherein edge regions of the casing side parts are angled down in such a way that they at least partially surround the casing frame.

28. A battery, comprising:
a plurality of single cells, each comprising
a first casing side part;
a second casing side part;
a casing frame;
an electrolyte and an electrochemically active electrode foil unit; and
an overpressure protection,
wherein the first casing side part comprises a casing side part segment at least sectionally along a length of the single cell, the casing side part segment is angled down in relation to the first casing side part in a direction of an interior of the cell, and an overpressure protection is arranged the side casing part segment, and a venting opening is incorporated in the casing frame in a region of the overpressure protection,
wherein plurality of single cells are electrically connected in series or in parallel to each other.

29. A method for producing a casing frame with a venting opening for use in a single cell, which comprises a first casing side part, a second casing side part, a casing frame, an electrolyte and an electrochemically active electrode foil unit, and an overpressure protection, wherein the first casing side part comprises a casing side part segment at least sectionally along a length of the single cell, the casing side part segment is angled down in relation to the first casing side part in a direction of an interior of the cell, and an overpressure protection is arranged the side casing part segment, and a venting opening is incorporated in the casing frame in a region of the overpressure protection, wherein
the first casing side part is arranged in an injection mould that is subsequently closed and filled with plastic, wherein a movable mould part of the injection mould is arranged on an angled down casing side part segment in a region of the overpressure protection.

30. The method according to claim 29, wherein the mould part is pressed spring loaded against the angled down casing side part segment.
